(19) United States
(12) Patent Application Publication
(10) Pub. No.: US 2010/0189991 A1
(43) Pub. Date: Jul. 29, 2010

(54) MACROPOROUS CARBON NANOFOAM COMPOSITES AND METHODS OF MAKING THE SAME

(76) Inventors: Justin C. Lytle, Alexandria, VA (US); Jeffrey W. Long, Alexandria, VA (US); Amanda June Barrow, Arlington, VA (US); Matthew Paul Saunders, Ithaca, NY (US); Debra R. Rolison, Arlington, VA (US); Jennifer L. Dysart, Arlington, VA (US)

Correspondence Address: NAVAL RESEARCH LABORATORY;ASSOCIATE COUNSEL (PATENTS), CODE 1008.2, 4555 OVERLOOK AVENUE, S.W., WASHINGTON, DC, 20375-5320, US

(21) Appl. No.: 12/620,541

(22) Filed: Nov. 17, 2009

Related U.S. Application Data
(60) Provisional application No. 61/115,250, filed on Nov. 17, 2008.

(51) Int. Cl. B32B 3/26; B05D 3/02

(52) U.S. Cl. 428/315.5; 427/227; 427/385.5

(57) ABSTRACT

A method is disclosed to fabricate carbon foams comprising a bicontinuous network of disordered or irregular macropores that are three-dimensionally interconnected via nanoscopic carbon walls. The method accounts for (1) the importance of wetting (i.e., matching the surface energies of fiber to sol) and (2) the viscosity of the microheterogeneous fluid filling the voids in the carbon paper. Carbon fiber papers are mildly oxidized by plasma etching, which greatly enhances the uniform uptake of resorcinol-formaldehyde (RF) mixtures. The RF solutions are oligomerized prior to infiltration and are cured into continuous polymeric webs that hang supported between adjacent carbon fibers; the polymer-fiber composites are pyrolyzed and retain a sponge-like morphology with 10-1000-nm pores and integrated electronic pathways

### CROSS-REFERENCE TO RELATED APPLICATIONS

This Application claims the benefit of U.S. Provisional Application 61/115,250 filed on Nov. 17, 2008, hereby incorporated herein in its entirety.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

Carbon foams with macroscopic porosities have been previously reported, but advanced carbon nanoarchitectures have since been fabricated as ultraporous electrodes for miniaturized energy storage devices (see R. W. Pekala, et al., J. Non-Cryst. Solids, 225, 74 (1998); E. Frackowiak et al., Carbon, 39, 937 (2001); M. Glora, et al., J. Non-Cryst. Solids, 285, 283 (2001), A. E. Fischer et al., ECS Transactions, 3, 61 (2007) and A. E. Fischer, et al., Nano Lett., 7, 281 (2007)) rapid chemical sensors (see C. Z. Lai, et al., Anal. Chem., 79, 4621 (2007)), and efficient separations media (see S. Villar-Rodil, et al., Chem. Mater., 14, 4328 (2002)).

Carbon aerogels were first prepared by Pekala in the late 1980s by forming polycondensate gels from dilute phenolic solutions, and then pyrolyzing the gels into low-density powders and monoliths comprising nanoscopic carbon domains with through-connected meso- and macroporosities. See R. W. Pekala, et al., J. Mater. Sci., 22, 1840 (1987) and R. W. Pekala et al., J. Mater. Sci., 24, 3221 (1989).

Resorcinol-formaldehyde (RF) chemistry has been exploited in order to form aerogel networks of polymeric colloids, whose sizes and interparticle spacings are tuned from tens of nanometers to a few micrometers (μm) by adjusting the pH of the precursor fluid (see C. Lin, et al., Carbon, 35, 1271 (1997)), the dilution of RF (see J. Shen, J. Wang, J. Zhai, Y. Guo, G. Wu, B. Zhou, and X. Ni, J. Sol-Gel Sci. Technol., 31, 209 (2004)), and the stoichiometric ratio of resorcinol, R, to either an acidic or alkaline catalyst, C (see S. A. Al-Muhtaseb and J. A. Ritter, Adv. Mater., 15, 101 (2003)). Alternatively, the pore structure of RF carbon monoliths is also influenced by ultrasonically disrupting RF oligomers at high resorcinol-to-catalyst (R/C) ratios (see N. Tonanon, A. Siyasukh, Y. Wareenin, T. Charinpanitkul, W. Tanthapanichakoon, H. Nishihara, S. R. Mukai, and H. Tamon, Carbon, 43, 2808 (2005)).

Carbon fibers have previously been incorporated as 3-D scaffolds for RF carbons, because the fibers impart mechanical reinforcement and additional conductive pathways. Most RF/carbon fiber composites have used as-received fiber papers without chemical modifications to the fiber surfaces thereby yielding dense RF coatings on individual fibers and incomplete volume filling of the interfiber voids. See, R. Petri\check{c}ević, M. Glora, and J. Fricke, Carbon, 39, 857 (2001); R. Petri\check{c}ević, M. Glora, A. Möginger, and J. Fricke, J. Non-Cryst. Solids, 285, 272 (2001); J. Wang, M. Glora, R. Petri\check{c}ević, R. Saliger, H. Proebstle, and J. Fricke, J. Porous Mater., 8, 159 (2001); M. M. Bruno, N. G. Cotella, M. C. Miras, and C. A. Barbero, Chem. Commun., 48, 5896 (2005); B. Crittenden, A. Patton, C. Jouin, S. Perera, S. Tennison, and J. A. B. Echevarria, Adsorption, 11, 537 (2005); and C. Schmitt, H. Pröbstle, and J. Fricke, J. Non-Cryst. Solids, 285, 277 (2001). Schmitt et al. inadvertently modified the chemical interface of carbon cloth by melting a Teflon binder at 200° C. in air, but did not report the effect of mild oxidation on the resulting RF carbon aerogel pore morphology. The surfaces of carbonaceous fabrics have previously been activated by plasma etching, see A. Inspektor, J. E. Koresh, S. S. Barton, and M. J. B. Evans, Carbon, 24, 325 (1986) and K. Okajima, K. Ohta, and M. Sudoh, Electrochim. Acta, 50, 2227 (2005), and by electrochemical oxidation, see Z. R. Yue, W. Jiang, L. Wang, H. Toghiani, S. D. Gardner, and C. U. Pittman, Jr. Carbon, 37, 1607 (1999), and it is known that these activations enhance the interactions of carbons with surrounding aqueous environs.

Colloidal-crystal-templated carbon monoliths are a close morphological analogue to carbon nanofoams, in that their interconnected macropores and skeletal structures fall within in a similar size regime, (see K. T. Lee, J. C. Lytle, N. S. Ergang, S. M. Oh, and A. Stein, Adv. Funct. Mater., 15, 547 (2005)). However, templating approaches require extensive synthetic and time costs.

Unsupported carbon aerogel films and monoliths can achieve pore sizes within a similar size regime as carbon nanofoams, but their low densities and the absence of an underlying fiber paper array impede electronic conduction. Carbon aerogels are also less flexible than fiber-supported nanofoams, which impairs their use in electrode structures relevant for device applications.

Fabric-supported RF carbons have never achieved the pearl necklace (solid)-macropore (void) architecture found in the carbon nanofoams described herein, and at best have porous voids on the order of a few micrometers.

The effort to design energy storage and conversion architectures in three dimensions (3D) has freed the designer with respect to the spatial arrangements and characteristic dimensions of the active components (anode, cathode, and electrolyte) of batteries, electrochemical capacitors, fuel cells, and photovoltaic devices. Ultraporous carbon structures in which the solid phase is co-continuous with an open, 3-D interconnected pore network offer an especially versatile architectural basis set with which to reconfigure the guts of multifunctional electrode structures. The electronically conductive carbon walls serve as a massively parallel 3-D current collector while the through-connected pore network facilitates transport of the molecular and ionic reactants necessary either to introduce new function to the architecture or as required during operation.

Carbon foams with macroscopic porosities have been reported for decades, but advanced carbon nanoarchitectures are now fabricated as ultraporous electrodes for miniaturized energy storage devicesr apid chemical sensors, and efficient separations media. Carbon aerogels were first prepared by Pekala in the late 1980s by forming polycondensate gels from dilute phenolic solutions, and then pyrolyzing the gels into low-density powders and monoliths comprising nanoscopic carbon domains with through-connected meso- and macroporosities, where mesopores are sized at 2-50 nm and macropores are >50 nm.

The phenolic-based polycondensation chemistry that creates the covalently established polymer network, which distinguishes these gels from entangled polymer gels such as hydrogels, is based on the venerable Bakelite chemistry from the early 1900s. Resorcinol-formaldehyde (RF) chemistry is commonly exploited in order to form networks of polymeric colloids, whose sizes and interparticle spacings are tuned from tens of nanometers to a few micrometers by adjusting the pH, the weight fraction of solids in the ultraporous RF polymer, and the stoichiometric ratio of resorcinol to either an acidic or alkaline catalyst. Alternatively, the pore structure of RF carbon monoliths can reportedly be influenced by ultrasonically disrupting RF oligomers at high resorcinol-to-catalyst (R/C) ratios.

As advantageous as the conductive carbon aerogel structure is for electrochemistry, it also poses several practical drawbacks. The brittle mechanical character and modest electronic conductivity of carbon aerogel monoliths (˜1 S cm⁻¹) typically necessitates pulverizing the architecture and forming composite structures with conductive additives and polymer binders. Scientists have responded to these challenges by incorporating either carbon fibers or carbon nanotubes into carbon aerogel precursors as conductive scaffolds or by using carbon fabrics or papers as the molding form in which to host the RF sol-gel process. In the latter approach, upon subsequent pyrolysis of the paper-supported foam to form conductive carbon, one obtains a foam-filled cloth that is a device-ready electrode with improved mechanical and electronic properties because the carbon fiber scaffolding imparts physical reinforcement, flexibility, and additional conductive pathways.

Most RF/carbon fiber composites, however, have used as-received carbon fiber papers without chemically modifying the fiber surfaces resulting in dense RF coatings on individual fibers and incomplete volume filling. Schmitt et al. inadvertently modified the chemical interface of carbon cloth by melting a Teflon binder at 200° C. in air, but did not report the effect of mild oxidation on the resulting RF carbon aerogel pore morphology.

A 3-D design limitation afflicting carbon aerogel monoliths, powders, and fiber-supported foams lies in the size of the plumbing—the pore network is mesoporous, typically with mesopores <25 nm. Although such a pore size range is ideal for electric double-layer capacitors (i.e., “supercapacitors”), the extension of carbon aerogels to more advanced electrochemical applications will require pore structures that bridge the macropore size regime. For example, introducing the internal multifunctionality necessary to fabricate 3-D battery, capacitor, and fuel-cell architectures must be accomplished without occluding the pore network, otherwise facile mass transport, which is crucial to these rate-critical devices, is compromised. Obtaining a macroporous interconnected free volume, particularly one with pores sized from 50 nm to several hundred nanometers, becomes a design necessity but this size range in the macroporous regime is less commonly achieved by the standard chemistry and processing used to prepare carbon aerogels and nanofoams.

### BRIEF SUMMARY OF THE INVENTION

A method is disclosed to fabricate carbon foams comprising a bicontinuous network of disordered or irregular macropores that are three-dimensionally interconnected via nanoscopic carbon walls. The method accounts for (1) the importance of wetting (i.e., matching the surface energies of fiber to sol) and (2) the viscosity of the microheterogeneous fluid filling the voids in the carbon paper. Nonpolar, nonaqueous precursor fluids can be directly infiltrated into the carbon paper. For processing with aqueous-based precursor fluids or polar organic-based precursor fluids, or mixed aqueous/polar organic-based precursor fluids, carbon fiber papers are mildly oxidized by plasma etching, which greatly enhances the uniform uptake of the fluid, for instance, aqueous resorcinol-formaldehyde (RF) monomer solutions are readily imbibed by carbon paper after mild oxygenation of the fiber surfaces because the treatment diminishes the hydrophobicity of the carbon fibers. The RF solutions are oligomerized prior to infiltration and are cured into continuous polymeric webs that hang supported between adjacent carbon fibers; the polymer-fiber composites are pyrolyzed and retain a sponge-like morphology with integrated electronic pathways and 50-250 nm pores. Depending on formulation and processing variants, 10-50 nm or 500 nm-˜1 μm pores can be obtained. The method disclosed herein uses low-cost and readily available precursors, and generates scalable, three-dimensionally porous nanoarchitectures for a range of applications including energy storage devices with or without minimal geometric footprints, active membranes (e.g., when electrified) for separation science, and conductive low-density supports for electrocatalytic nanoparticles. The porous carbon nanofoam architecture can serve as a stand-alone Li-ion-insertion anode, as a nanoscopic current collector for solid-state batteries, including microbatteries, in which all electrochemical components are fully interpenetrated in three dimensions, as 3-D hybrid electrochemical capacitors, or as porous scaffolds for fuel-cell electrodes.

### BRIEF DESCRIPTION OF THE DRAWINGS

FIG. 1 shows a scanning electron micrograph of 0.2 g cm⁻³ carbon fiber paper (Lydall Filtration/Separation, Inc.).

FIG. 2 shows scanning electron micrographs of carbon nanofoams with macropores sized at 100-300 nm (and containing few micropores or micrometer-sized pores) as imaged at various magnifications.

FIG. 3 shows scanning electron micrographs of the cross-section of carbon-fiber-paper-supported carbon nanofoams with macropores sized at >100 nm (and containing few micropores or micrometer-sized pores) as imaged at two magnifications.

FIG. 4 shows carbon-fiber-paper-supported polymer nanofoams in which the carbon-fiber paper is scaled up in the x-y direction (increase in geometric area) to 10 cm×10 cm—a size of relevance for macroscale batteries and fuel-cell electrodes.

FIG. 5 shows scanning electron micrographs of the surface and cross-section of a polymer-coated carbon nanofoam that is passivated to (i.e., shuts off) electron transfer to a redox probe as achieved by completely painting the walls (internal and external) of the 0.1-0.2-mm-thick fiber-supported carbon nanofoam with a self-limiting polymer film (via the oxidation of phenol monomer in the electrolyte) and then filling with a precursor fluid to deposit RuO₂ (s) within the remaining free volume of the pore network.

FIG. 6 shows scanning electron micrographs of palladium-carbon nanoarchitectures of interest for fuel-cell and synthetic applications.

FIG. 7 shows the process of preparing the carbon nanofoams.

### DETAILED DESCRIPTION OF THE INVENTION

Before the present invention is described in detail, it is to be understood that this invention is not limited to the particular methodology, devices, solutions or apparatuses described, as such methods, devices, solutions or apparatuses can, of course, vary. It is also to be understood that the terminology used herein is for the purpose of describing particular embodiments only, and is not intended to limit the scope of the present invention.

Use of the singular forms “a,” “an” and “the” include plural references unless the context clearly dictates otherwise. Thus, for example, reference to “a substrate” includes a plurality of such substrates.

Terms such as “connected,” attached,” “linked,” and “conjugated” are used interchangeably herein and encompass direct as well as indirect connection, attachment, linkage or conjugation unless the context clearly dictates otherwise.

Where a range of values is recited, it is to be understood that each intervening integer value, and each fraction thereof, between the recited upper and lower limits of that range is also specifically disclosed, along with each sub-range between such values. The upper and lower limits of any range can independently be included in or excluded from the range, and each range where either, neither or both limits are included is also encompassed within the invention. Where a value being discussed has inherent limits, for example where a component can be present at a concentration of from 0 to 100%, or where the pH of an aqueous solution can range from 1 to 14, those inherent limits are specifically disclosed. Where a value is explicitly recited, it is to be understood that values which are about the same quantity or amount as the recited value are also within the scope of the invention. Where a combination is disclosed, each subcombination of the elements of that combination is also specifically disclosed and is within the scope of the invention. Where any element of an invention is disclosed as having a plurality of alternatives, examples of that invention in which each alternative is excluded singly or in any combination with the other alternatives are also hereby disclosed; more than one element of an invention can have such exclusions, and all combinations of elements having such exclusions are hereby disclosed.

Unless defined otherwise or the context clearly dictates otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

All publications mentioned herein are hereby incorporated by reference for the purpose of disclosing and describing the particular materials and methodologies for which the reference was cited.

A method is disclosed to fabricate carbon foams comprising a bicontinuous network of disordered mesopores to macropores that are three-dimensionally interconnected via nanoscopic carbon walls. The method accounts for (1) the importance of wetting (i.e., matching the surface energies of fiber to sol) and (2) the viscosity of the microheterogeneous fluid filling the voids in the carbon paper. Nonpolar, nonaqueous precursor fluids can be directly infiltrated into the carbon paper. For processing with aqueous-based precursor fluids or polar organic-based precursor fluids, or mixed aqueous/polar organic-based precursor fluids, carbon fiber papers are mildly oxidized by plasma etching, which greatly enhances the uniform uptake of aqueous resorcinol-formaldehyde (RF) monomer solutions by diminishing the hydrophobicity of the carbon fibers. The RF solutions are oligomerized prior to infiltration and are cured into continuous polymeric webs that hang supported between adjacent carbon fibers; the polymer-fiber composites are pyrolyzed and retain a sponge-like morphology with integrated electronic pathways and 50-250 nm pores (or based on formulation or processing variants 10-50 nm or 500 nm-˜1 μm pores). The method disclosed herein uses low-cost and readily available precursors, and generates scalable, three-dimensionally porous nanoarchitectures for a range of applications including energy storage devices with or without minimal geometric footprints, active membranes (e.g., when electrified) for separation science, and conductive low-density supports for electrocatalytic nanoparticles. The porous carbon nanofoam architecture can serve as a stand-alone Li-ion-insertion anode or as a nanoscopic current collector for solid-state batteries, including microbatteries, in which all electrochemical components are fully interpenetrated in three dimensions, as 3-D hybrid electrochemical capacitors, or as porous scaffolds for fuel-cell electrodes.

Carbon nanoarchitectures are a versatile foundation for the design of multifunctional electrode structures that enable key energy storage and conversion technologies. The ultraporous carbon nanoarchitecture serves as a massively parallel 3-D current collector and as a structural flow field that facilitates efficient transport of electrons, ions, and molecules. Carbon nanofoam papers are fabricated by infiltrating commercially available low-density carbon fiber papers with phenolic resin. Pyrolysis of the resulting composite creates lightweight, mechanically flexible, and electronically conductive sheets of ultraporous carbon. The resulting materials comprise nanoscopic carbon walls that are co-continuous with an aperiodic, 3-D interconnected network of mesopores (2 to 50 nm) and macropores (50 nm to 2 μm)—the latter size range has not been adequately explored in the literature and it offers ample headspace to support additional functionalities on the carbon walls without occluding the void volume of the nanofoam. Matching the surface energetics of the carbon fibers and polymer sol is necessary to avoid forming a standard carbon aerogel pore-solid structure, where the pores are sized in the micropore (<2 nm) and small mesopore range (<20 nm). Carbon nanofoam papers can be scaled in x, y, and z and are device-ready electrode structures that do not require conductive additives or polymeric binders for electrode fabrication. This one class of nanofoams serves as a high-surface-area scaffold that can be segued by appropriate modification into multifunctional nanoarchitectures that improve the performance of electrochemical capacitors, lithium-ion batteries, metal-air batteries, fuel cells, and ultrafiltration.

Synthesis of Carbon Nanofoam Papers. In order to ensure such a desirable assemblage of properties—electronic conductivity of ˜10²S cm⁻¹ rather than ˜1 S cm⁻¹, mechanical ruggedness coupled to paper-like flexure, pores sized on the order of 10² nm, and device-ready construction—it is necessary to match the surface energy of the carbon fibers to that of the infiltrating aqueous-based organic sol. The carbon fiber papers with interfiber voids on the order of micrometers are mildly oxidized by glow-discharge plasma etching in humidified air for 30 min, which greatly enhances uniform uptake of aqueous RF-based precursor sols by diminishing the hydrophobicity of the carbon fibers.

Strategies to oxygenate the surface of carbon electrodes, fibers, and powders often involve chemical methods sufficiently harsh (soaking in nitric acid or strong alkali, heating in air/oxygen, or ozonolysis) that the mechanical character of the fibers is degraded. Vacuum infiltrating aqueous electrolyte and potential cycling the carbon structure is also a gentle means to accomplish mild surface oxidation, but requires a labor/time-intensive processing step. Activating the surfaces of carbonaceous fabrics by plasma etching in oxygen is known to enhance interaction with aqueous environs, increase double-layer capacitance, and improve uptake of metal ions. The greatest reproducibility in high-quality infiltration arises by using deliberately humidified air (adding ice chips into the plasma chamber) rather than dry air or ambient air. It has been previously reported that water plasmas are effective in oxygenating the surfaces of pyrolytic graphite.

X-ray photoelectron spectroscopy indicates an increase in carbon oxygenates after treating in a H₂O plasma and high-resolution scanning electron microscopic study of the surface morphology of the PAN-derived fibers in the Toray and Lydall papers indicate roughening and texturing post-treatment.

The RF solutions are oligomerized for 3 h at room temperature prior to infiltration into the carbon paper to increase the viscosity of the sol and to minimize the amount of unreacted formaldehyde that can volatilize during the handling necessary to infiltrate the sol into the papers. Upon infiltration, the papers are sandwiched between glass slides (to match the hydrophilicity of the glass to the hydrophilic boundary of the sol-infused paper) and the assembly is hermetically sealed and cured in a pressure cooker. One would employ cover slips or slides with hydrophobic surfaces (e.g., perfluorinated polymers) with nonpolar formulations of the polymer precursor fluid. This hydrothermal step using commercial cooking equipment is similar to the manufacture-scale pressure cooker used by Baekeland and coworkers. The paper-confined sol cures into continuous polymeric webs that hang supported between adjacent carbon fibers; the paper-supported nanofoam is rinsed with acetone to remove residual water and then dried ambiently—no supercritical fluid extraction is necessary. The RF polymer nanofoam-carbon fiber composites are pyrolyzed at about 1000° C. to form a carbon nanofoam paper that retains a sponge-like morphology with integrated electronic pathways via the nanoscale carbon network. The weight fraction of carbon nanofoam within the supporting fiber matrix is typically 50%.

Scanning electron microscopy (SEM) confirms that the carbon nanofoam uniformly occupies the void volume between fibers in the paper while making a high-quality interface with the fiber. The exterior of the composite has a pearl-necklace pore morphology that extends throughout the paper within which RF-carbon colloids have bonded into a 3-D carbon network that is bicontinuous with a network of interconnected macropores sized at ˜50-200 nm. Note that the wall thickness of the carbon network is on the order of 20 nm, unlike recently reported hierarchical carbon aerogels with comparably sized pores (10²-10³ nm) but in which the carbon wall thickness was submicrometer-thick and supercritical drying of the polymer monoliths was still required.

The interior of the paper retains the large mesopores and small macropores present at the surface. Neither the surface pore structure nor interior pore structure resembles the classical carbon aerogel morphology that consists of small macropores that are tightly confined by a network of RF-derived carbon colloids.

Nitrogen porosimetry indicates that BET (Brunnauer-Emmett-Teller) surface areas are on the order of 200-400 m²g⁻¹, where higher RF weight percentages and ˜50-nm pores yield the higher values in the range. Although micropores are present in the carbon walls, as is customary for pyrolyzed RF polymers, the fraction of pore volume that is microporous is only on the order of 10%. The materials are not designed for especially high surface areas and the coupled content of micropore volume because the application space is focused on rate-critical processes with time scales at which micropores are electrochemically silent.

Mercury porosimetry of select samples yielded information on the pore structure of the nanofoams for pores sized at >150 nm (above which N₂ porosimetry fails).

Raman spectroscopy indicates that the pyrolyzed carbon comprising the solid network in the nanofoam is consistent with that obtained for RF-derived carbon aerogels. The bands for defective (D) and graphitic (G) carbon are present and the breadth of both bands is consistent with the absence of long-range order in the carbonaceous solid.

X-ray photoelectron spectroscopy of the as-pyrolyzed vs H₂O-plasma-treated nanofoams show the expected increase in Ols photoelectron intensity. Deconvolution of the Cls region at binding energies >286 eV indicate oxygenates consistent with aliphatic (aromatic) hydroxylated/carboxylated speciation.

The conductivity of the fiber-supported carbon nanofoams tracks the conductivity of the particular paper used. The higher fiber count (ρ˜0.4 g cm⁻³) Toray paper originally used has an innate electronic conductivity of ˜220 S cm⁻¹, while the Lydall paper with a lower fiber count (and half the density) yields a conductivity of 20-80 S cm⁻¹.

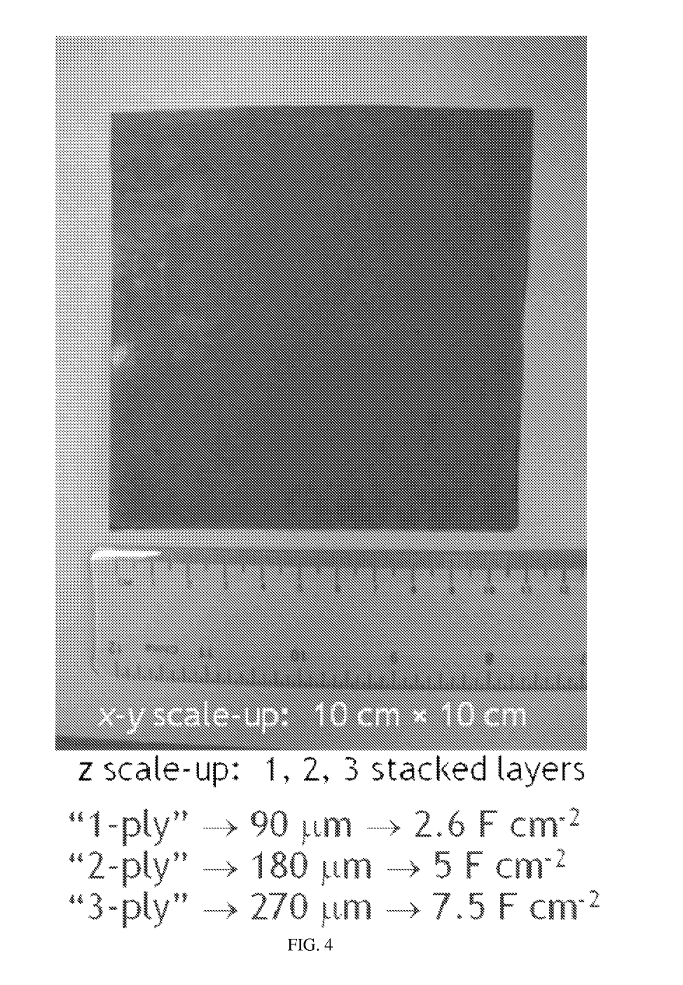

Scability of Carbon Nanofoam Papers. Infiltrating a liquid-based precursor sol into paper as the mold that shapes the form of the final polymer gel permits a ready scale-up of the nanofoam-filled carbon paper. One can scale in x-y, as shown in FIG. 4, in which the initial carbon fiber paper is cut as large as 10 cm×10 cm and a high-quality polymeric RF filling is still achieved. One can also scale in the z direction by stacking multiple layers of carbon paper that are then glued by the forming polymer into a thicker paper. This one-ply, two-ply, three-ply approach retains the through-connected porous network as seen by the increase in areal normalized electrochemical capacitance when “painting” the carbon walls with MnO₂.

Structural Character of Carbon Nanofoam Papers Relative to Previous Carbon Aerogels and Fiber-Reinforced Carbon Nanofoams. These carbon nanofoam-carbon fiber composites offer a set of structural characteristics that differ from those of existing porous carbon materials. The nanofoam architecture retains nanometric carbon walls and large surface areas that are bicontinuously interconnected via a network of ˜10-1000 nm pores. Pore sizes in this regime are ideally proportioned for amplifying electrochemical interactions necessary for energy storage and conversion. For example, the macropores in carbon nanofoams are perfectly sized and through-connected to accommodate the fluid transport and build-up of nanoparticles and molecular species, but are small enough that valuable device volume is not wasted on the cavernous voids found in most cellular carbon foams (10 s-100 s μm). In contrast, chemical fluxes are impeded by the diffusion limitations of the micropores (<2 nm) and mesopores (2-50 nm) that comprise most high-surface-area carbons.

The pearl-necklace macropore morphology and dimensions of carbon nanofoam materials are unprecedented among other forms of carbon in the literature. Without being bound to the specific theory, it is believed that the low-density nanofoam structure is attributed to the electrostatic and dipole—dipole interactions between the carbon fiber paper after it has been mildly oxidized via plasma etching in moist air and the RF sol when it reaches an optimal viscosity upon oligomerizing for 4 h prior to infiltration. The plasma activation of carbon fibers is an established method that enhances the proton capacitance and uptake of metal ions at the increasingly polarized carbon interface. In the absence of fabric supports, RF-carbon aerogel monoliths and films have been reported with micron-sized pores, but lack the electronic conductivity that is required for high-rate electrochemical devices and the range of flexibility that the fabric provides. Carbon nanofoam composites exhibit four-point electronic conductivities as high as ˜200 S cm⁻¹, whereas unsupported RF carbon aerogels are at best only conductive to a few S cm⁻¹ because of their non-graphitized, low-density structures.

Likewise, fiber-supported RF-carbon aerogels have never achieved a similar macroporous morphology as the carbon nanofoam network, likely because none of the published reports pre-activate carbon fibers using plasma, thermal, or electrochemical etching. Under the best conditions, micron-scale RF-carbon granules are loosely assembled around fibers to create macropores on the order of a few microns. Most often, though, RF-carbon globules comprised of small mesopores coat the individual fibers but do not occupy a large fraction of the void volume in the paper. Fiber composites with poor loading diminish the electrochemical activities of carbon electrodes per unit area and volume.

Synthesis of polymer and carbon nanofoams in carbon fiber paper: The weight fraction of resorcinol-formaldehyde (RF) sol can be varied from 10-50 wt %, but the choice depends on the end use and the density of the carbon fiber paper. Lower RF wt % protocols (10-25 wt % RF) work better with higher density papers (0.4 mg cm⁻³), while lower density papers (0.2 g cm⁻³) require RF weight loadings of 30-50 wt %. A standard protocol, detailed below, uses 40 wt % RF. The weight fraction of solids is determined using: [gR+(gF*0.37)]/(gR+gF+gH₂O)].

Preparation of 40 wt % RF sol. Resorcinol (4.251 g) and sodium carbonate (2.70 mg) are dissolved in water (5.89 g) with stirring for 15 min. The polymerization is initiated by introducing formaldehyde (6.26 g, 37% solution) into the stirring R/C solution. This solution is tightly sealed in a glass jar, stirred for 30 min, and oligomerized at room temperature for approximately 3 h—all handling occurs in a hood to minimize exposure to formaldehyde. Amounts are scaled up depending on the size and number of papers to be made.

Preparation of Carbon Papers and Glass Slides. Glass Microscope Slides (Fischer Chemicals) are cut to 2.75×2.5 cm² dimensions, degreased with acetone, and air dried. Toray carbon fiber papers (TGP-050, density 0.40 g cm⁻³, 110-μm thick) or Lydall (density 0.2 g cm⁻³, 90-μm thick) are cut in 2.5×1.5 cm² strips and plasma etched (Harrick plasma cleaner; 30 W setting) in the presence of air and ice chips (equivalent to ˜5 mL of water) for 30 min at 0.4-0.8 ton. The presence of water vapor during plasma etching further increases the hydrophilic properties of the fiber paper.

Assembling paper-molded RF-nanofoams: Two plasma-etched papers are submerged into the oligomerized RF sol, two per jar; loosely cap the jars and place in a vacuum desiccator (all done in the hood). A vacuum is pulled until infiltration is observed (the papers rise to the top of the liquid, but the sol is not boiling, several seconds). A pair of papers are placed on one half of the glass slide, wetted with additional drops of the RF sol via a glass pipette, and covered with the other half of the glass slide. Air bubbles are removed by attaching a mini binder clip at one end, creating a “V” in the slide. The meniscus of the RF solution is swept across the paper as the slides are brought into contact, and the slides are clamped in place with mini binder clips such that the clips are offset from the fiber paper. The clips are detached from the binder, and the entire assembly is wrapped tightly with one layer of duct tape to slow solvent evaporation. Repeat these steps with all of the plasma-treated papers. All duct tape packages are then wrapped in aluminum foil and placed in the pressure cooker (Nesco 3-in-1 pressure cooker (Target); slow-cook setting, ˜88° C., 9.5 h); see FIG. 7 for photographs of the stepwise assembly.

Processing paper-supported RF nanofoam to paper-supported carbon nanofoam. After slow cooking, the packets are unwrapped and the RF nanofoam papers are submerged in water and rinsed for a few hours. The papers are then rinsed with acetone for ˜1-2 h, air dried, and weighed. The RF nanofoam papers are heated under argon at 0.05° min⁻¹ for 1 h and then at 1° min⁻¹ to 1000° C. for 2 h. The pyrolyzed papers are cooled to room temperature at 1° min⁻¹ and re-weighed.

Scaling paper-supported nanofoams in x-y-z. To scale in x-y, simply cut the carbon fiber paper and glass slides to the desired larger size; 10 cm×10 cm can be achieved without significant deviation from the processing protocol. To scale in z, simply stack the sol-infiltrated papers atop one another to the desired number of layers before sandwiching between the glass slides and processing as described above.

Physical characterization. Electron Microscopy. Scanning electron microscopy (SEM; Carl Zeiss Supra 55) was used to characterize the structure of the pore-solid networks in the paper-supported nanofoams. We examine multiple areas of order 100 μm×100 μm from each sample to ensure that the images we obtain are representative. Specimens were analyzed at the outer surfaces of the paper-supported nanofoams and via cross-section. Freeze-fracturing damaged the interior of the foam, so cross-sections were prepared by slicing a nanofoam heated to 60° C. using a scalpel warmed to 40° C. For micrographic analysis, the specimen was prepared by attaching a small portion of the aerogel monolith to an aluminum stub using conductive silver epoxy (Circuit Works). The epoxy was cured at room temperature in air for 1 h followed by heating in air at 100° C. for 2 h. Specimens were not sputter-coated prior to analysis.

Porosimetry. Surface area and porosities were determined by nitrogen physisorption (Micromeritics ASAP2010 accelerated surface area and porosimetry analyzer) to determine surface area and pore volume associated with pores sized <300 nm and by mercury porosimetry (Micromeritics, Ga.) to determine pore size distribution for pores up to 300 Ξm. For N₂ physisorption, all samples were degassed at 80° C. for at least 24 h prior to characterization. Pore-size distributions were calculated from adsorption isotherm data using Micromeritics DataMaster software (DFT_Broekhoff-de Boer model, classical cylindrical pore geometry).

Spectroscopy. X-ray photoelectron spectroscopy was used to determine the C/O ratio of the pyrolyzed carbon nanofoams.

Electrochemistry. The electrochemical capacitance of 1-, 2-, and 3-ply carbon nanofoams was determined before and after surface modifying the interior walls with ˜10-nm-thick coatings of MnO₂ (prepared using a self-limiting oxidation of the carbon surfaces with MnO₄− as previously described).

### Example 1

Low-density RF polymers are deposited on carbon fiber papers by the following technique. All samples were prepared from a resorcinol-to-formaldehyde (R/F) ratio of 1:2 and a R/C ratio of at least 1500:1 All reagents were purchased from Aldrich, and were used without further purification. Glass microscope slides purchased from Fisher Chemicals were cut to 2.75 cm×2.5 cm dimensions and degreased with acetone. Toray carbon fiber papers (TGP-050, density ˜0.4 g cm⁻³, 110-μm thick) and Lydall Technimat® carbon fiber papers (6100-050, density ˜0.2 g cm⁻³, 384-μm thick) were cut in 2.5 cm×1.5 cm strips and plasma etched (30 W) in the presence of moist air (0.4-0.8 ton) for 30 min. Carbon fiber paper is hydrophobic because of its nonpolar carbon bonds; plasma etching oxidizes the carbon fiber surfaces and permits the aqueous RF solution to fully infiltrate the paper. The presence of water vapor during plasma etching further increases the hydrophilic properties of the fiber paper.

Resorcinol (6.748 g) and sodium carbonate (2.15 mg) are dissolved in water (18.101 g), with stirring for fifteen minutes. The polymerization is initiated by introducing formaldehyde solution (9.948 g) into the stirred solution. After formaldehyde addition, the solution is tightly sealed in a glass jar, stirred for several minutes, and oligomerized for 4 h. After oligomerizing the RF solution, fiber papers are submerged into the solution and rest in the same sealed container for 30 min to fully impregnate the fiber scaffold with the RF mixture.

After immersion, the RF-wetted carbon fiber strips are sandwiched between two glass slides. Air bubbles are removed by attaching one clip and creating a “V” on the slide. The meniscus of the RF solution is swept across the paper as the slides are brought into contact, and the slides are clamped in place with mini binder clips such that the clips are offset from the fiber paper. Those skilled in the art would understand that any joining means that would eliminate bubbles would work as well. The metal finger clips are detached from the binder clips, and the entire assembly is wrapped tightly with at least one layer of duct tape to slow solvent evaporation. Those skilled in the art would understand that any assembly means that would slow solvent evaporation would work as well. The duct-taped cells are lightly covered in an aluminum foil pouch, and the RF/carbon fiber composite is cured in a pressure cooker at ˜88° C. for about 9.5 h. The papers are subsequently removed from their cells, and are exchanged in 100 mL of absolute ethanol over 24 hours in order to displace residual water in the porous structure. Preferably, the papers are exchanged three times. Excess ethanol is gradually evaporated from the RF/carbon fiber composites under flowing nitrogen for approximately 1 h. Those skilled in the art would understand that other means of evaporating the excess ethanol may work. The resulting RF-infiltrated carbon fiber papers exhibit minor domains of incomplete filling, which we attribute to air bubbles that are trapped at the imperfectly flat surface of the glass slides.

The RF nanofoam network is carbonized by heating the composite papers in flowing Ar(g) at 4° C. min⁻¹ to 1000° C. and isothermally heating at 1000° C. for 2 h.

Cross-sectional images acquired by scanning electron microscopy (SEM) confirm that RF-carbon nanofoam uniformly occupies the void volume between fibers in the paper. The pearl-necklace pore morphology seen at the exterior of the composite extends throughout the paper, in which RF-carbon colloids have fused into a 3-D carbon network that is bicontinuous with interconnected macropores of ˜50-500 nm.

### Example 2

The Lydall paper (2.5 cm (or multiple of 2.5 cm)×1.5 cm dimensions) was plasma etched in a Harrick Plasma PDC-3XG Plasma Cleaner for 30 min @ 30 W (Hi-power) in air/ice plasma. A small beaker (5 mL) filled with ice is placed in the plasma cleaner, and strips of Lydall paper are aligned along the inside walls of the chamber. The Plasma Cleaner door (with valves closed) is installed and the chamber is pumped down to a low enough pressure for the plasma to appear. The valves on the door are adjusted to let enough air into the chamber to form a bright neon purple plasma without quenching the plasma.

The preferred embodiment of the standard RF solution mixture is 40 wt % 1500 R/C RF. Combine 4.251 g of resorcinol (Aldrich, 99%+), 5.89 g of NANOpure water (Barnstead, 18 MΩ cm), and 0.0027 g of Na₂CO₃ (Aldrich). This mixture is stirred until it completely dissolves (˜10 min). A small stir bar and 20-mL glass scintillation vial may be used for this purpose. 6.26 g of formaldehyde (37 wt % water stabilized, Aldrich) is added to the solution and stirred for ˜10-15 min. until the solution is relatively homogeneous and less turbid-looking.

Immediately after the RF solution is prepared, the stir bar is removed from the vial and the Lydall papers are individually immersed for approximately 1-2 min in the RF solution. The RF-impregnated Lydall papers (2.5 cm×1.5 cm) are then sandwiched individually between pre-cleaned (in acetone) glass microscope slides (cut in half, ˜3.75 cm×2.5 cm). These sandwiched samples are clamped on the ends to form a thin film of RF solution on the Lydall papers. Then each of these sandwich assemblies is wrapped in at least one layer of duct tape to retard evaporation.

The samples are loosely covered in an Al foil pouch to protect them from dripping water in the pressure cooker.

The Al foil pouch covered samples are placed in a pressure cooker and cured overnight. The pressure cooker is set at ˜90° C. for ˜9.5 h, then the temperature is reduced to ˜70° C. for at least 1-4 h; the samples are then removed from the pressure cooker. Each sample is then unwrapped and placed directly into a glass jar of NANOpure water.

The samples are then immersed in NANOpure water for at least 1-4 h, replacing the water at least once during this time. Those skilled in the art would understand that the water is used to remove the excess reagents remaining in the sample and the immersion time relates to the time required to achieve the result. The water is then exchanged for acetone, and the samples are immersed in the acetone for at least one to four hours. Those skilled in the art would understand that the acetone is used to replace the water, and the immersion time is related to the removal of acetone. The acetone is exchanged at least once during this time period.

After proper solvent exchange, the acetone is decanted from the samples. The samples are then allowed them to dry ambiently (RT), in an open jar for 1-2 h.

After the samples are dry, they are pyrolyzed at 1000° C. for 2 h in a tube furnace under Ar flow (79.5 mL/min).

### Example 2

Carbon nanofoams with pore sizes in the 10-50-nm range were prepared using the method previously described. 20 g of resorcinol, 29.4 g of formaldehyde, 12.3 g of H₂O, 0.0384 g of Na₂CO₃ were combined and stirred for 30 minutes. The resulting mixture was allowed to stand at room temperature for 2.5 hours. The resulting RF sol was then infiltrated into the carbon fiber-paper, in accordance with the method of Example 1 and 2. The RF-impregnated papers were then packaged and placed in a table-top pressure cooker at 90° C. for at least 9 h to form the RF-polymer nanofoam paper having pore sizes in the range of from about 10 nm to about 50 nm.

### Example 3

Carbon nanofoams with pore sizes in the range of 500 to 1000 nm were prepared using the method previously described in Examples 1 and 2. Resorcinol (7.0932 g), 10.4842 g of formaldehyde (37%), 9.8589 g of H₂O, and 0.0045 g of sodium carbonate were stirred together for about 30 min. The resulting solution was allowed to stand at room temperature for about 5 h. The resorcinol-formaldehyde (RF) sol was then infiltrated into carbon fiber-paper by the method described in Example 1. The resulting RF-nanofoam papers were allowed to sit at room temperature for 6 days. The RF-nanofoam papers were then heated at 90° C. in a table-top pressure cooker for 12 h to form the final RF-nanofoam paper.

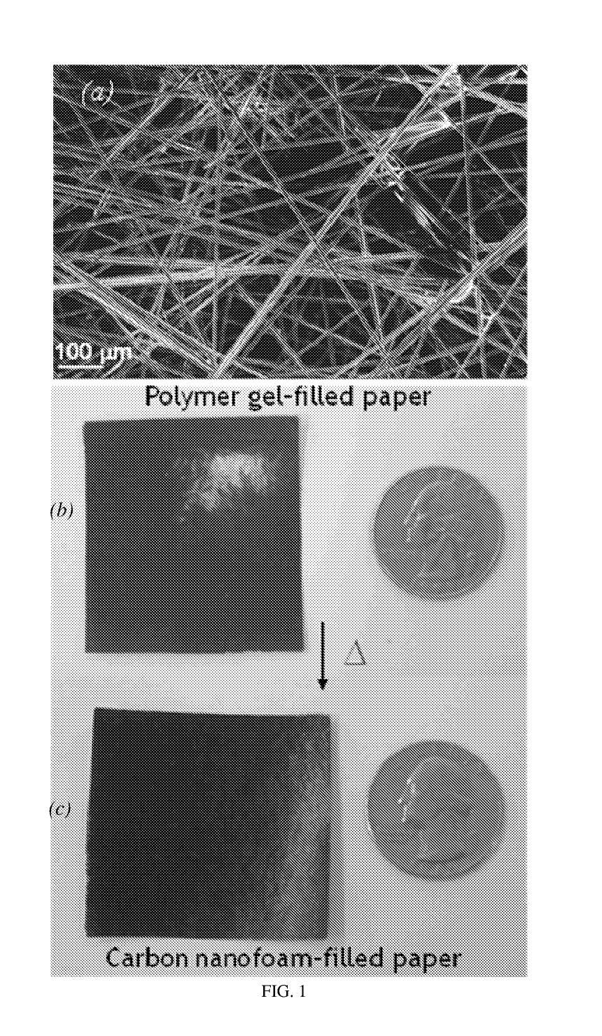

FIG. 1 shows (a) scanning electron micrograph of 0.2 g cm⁻³ carbon fiber paper (Lydall Filtration/Separation, Inc.). Photographs of carbon-fiber-supported RF foam before (b) and after (c) pyrolysis at 1000° C. in flowing argon to form carbon-fiber-supported carbon nanofoam. Note that the shiny regions seen in (b) and (c) are reflections from the polymer nanofoam (b) and carbon nanofoam (c) and are not unfilled or torn regions in the carbon fiber paper.

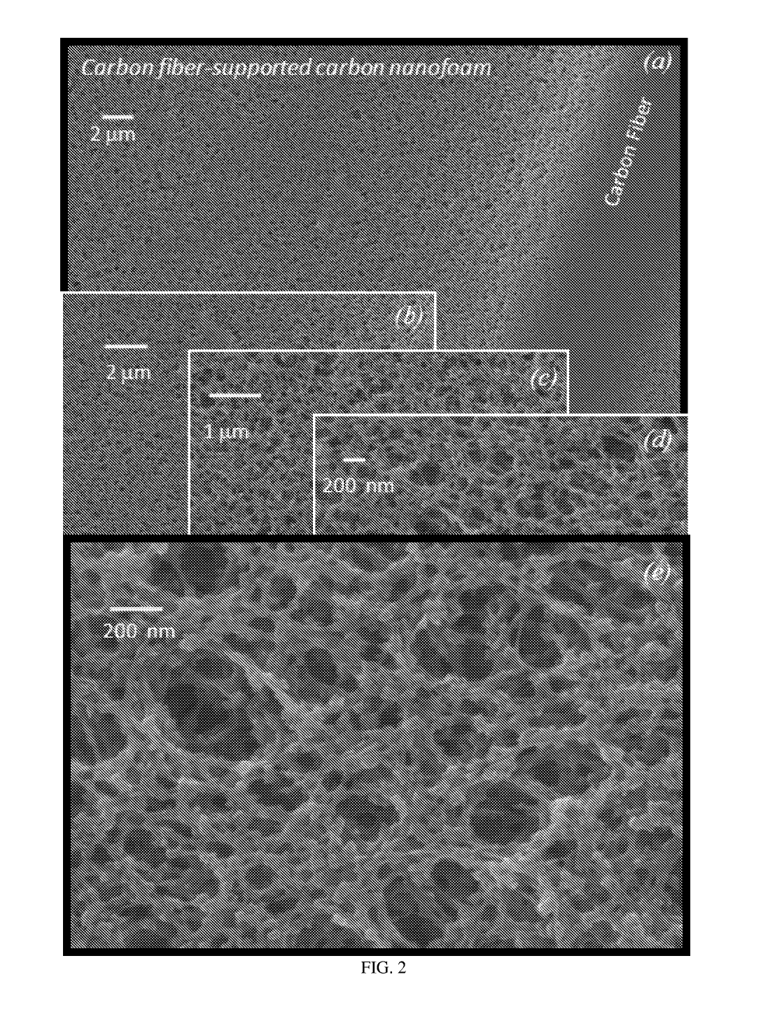

FIG. 2 shows scanning electron micrographs of carbon nanofoams with macropores sized at 100-300 nm (and containing few micropores or micrometer-sized pores) as imaged at various magnifications. The images demonstrate (1) the high quality of the contact at the interface between the carbon fiber and the nanoscale network of carbon aerogel; (2) the desirable “pearl necklace” carbon micro/nanostructure of the carbon nanofoam; and (3) how this pore-solid architecture provides I-beams and cross-ties that improve mechanical ruggedness and maintain the structure of the open, through-connected 3-D porous network; note that the shiny regions seen in FIG. 2b and FIG. 2c are reflections from the polymer nanofoam (FIG. 2b) and carbon nanofoam (FIG. 2c) and are not unfilled or torn regions in the carbon fiber paper.

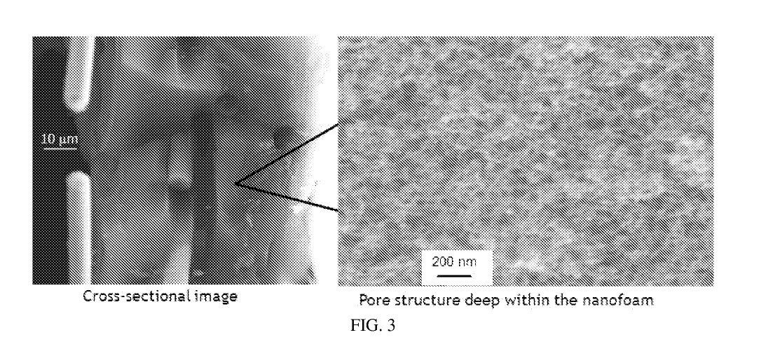

FIG. 3 is scanning electron micrographs of the cross-section of carbon-fiber-paper-supported carbon nanofoams with macropores sized at >100 nm (and containing few micropores or micrometer-sized pores) as imaged at two magnifications. The images demonstrate (1) the high quality of the nanofoam fill throughout the thickness of the carbon fiber paper; and (2) retention of interconnected macropores deep within the center of the paper-supported carbon nanofoam.

FIG. 4 shows carbon-fiber-paper-supported polymer nanofoams in which the carbon-fiber paper is scaled up in the x-y direction (increase in geometric area) to 10 cm×10 cm—a size of relevance for macroscale batteries and fuel-cell electrodes. The paper-supported polymer or carbon nanofoams may also be scaled up in the z direction (increased thickness) by stacking multiple pieces of paper and interfiling with the oligomerized precursor fluid. Upon polymerization all layers are bonded together by the polymer nanofoams and retain structural integrity upon pyrolysis in flowing argon at 1000° C. The areal capacitances were obtained for paper-supported nanofoams modified with ˜10-nm-thick conformal layers of manganese dioxide using the protocol developed by A. E. Fischer et al. (Nano Lett., 7, 281 (2007), incorporated herein in its entirety). The linear increase in geometric area-normalized capacitance of the electrode structure with thickness (˜2.5 Farads per 90-μm-thick layer of paper) demonstrates the high quality of the three-dimensionally interconnected network of macropores through one, two, and three layers of nanofoam-filled carbon-fiber paper.

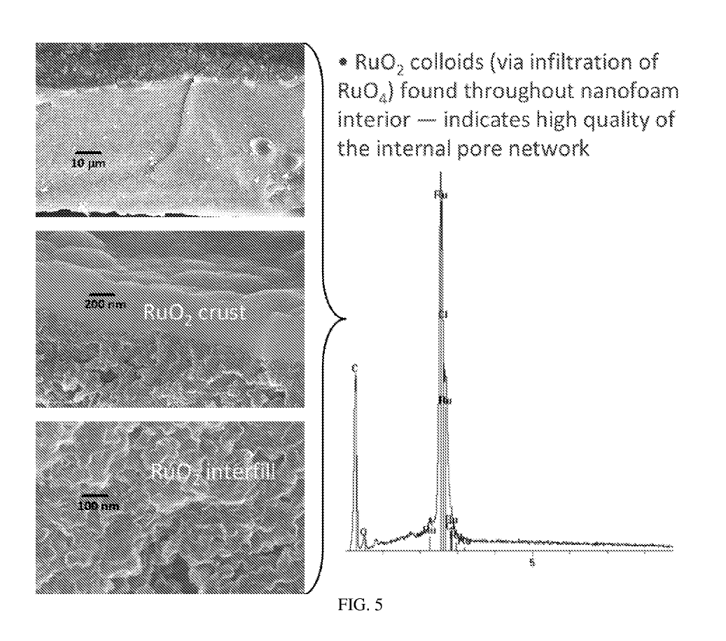

FIG. 5 shows scanning electron micrographs of the surface and cross-section of a polymer-coated carbon nanofoam that is passivated to (i.e., shuts off) electron transfer to a redox probe as achieved by completely painting the walls (internal and external) of the 0.1-0.2-mm-thick fiber-supported carbon nanofoam with a self-limiting polymer film (via the oxidation of phenol monomer in the electrolyte). The polymer-modified carbon nanofoam is then filled with a precursor fluid to deposit RuO₂(s) within the remaining free volume of the pore network: both internal modifications are possible because the high-quality 3-D macropore network allows facile ingress and egress of precursor species.

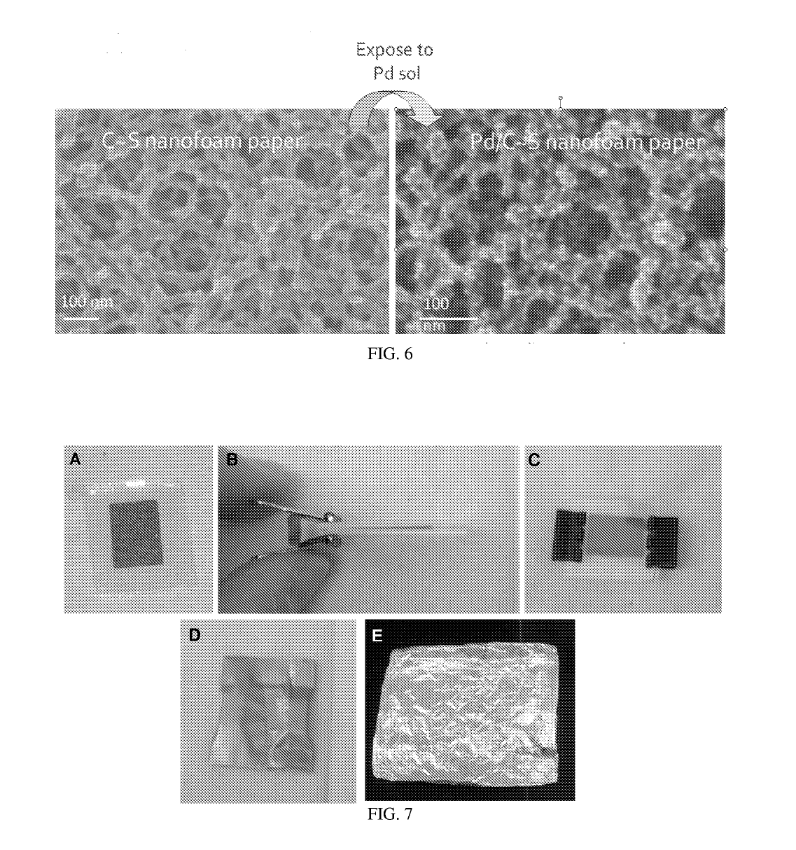

FIG. 6 shows scanning electron micrographs of palladium-carbon nanoarchitectures of interest for fuel-cell and synthetic applications (H₂O₂-reduction catalyst; alcohol oxidation catalyst), gas sorption/storage, and sensors in which the paper-supported polymer nanofoam was thiophenylated using the protocol developed for carbon aerogels by W. S. Baker et al. (J. Non-Cryst. Solids, 350, 80 (2004) and J. W. Long et al. (U.S. Pat. No. 7,282,466, issued Oct. 16, 2007, and U.S. Pat. No. 7,442,747, issued Oct. 28, 2008), the entirety of all incorporated herein by reference; the sulfur anchor is retained upon pyrolysis at 1000° C. in flowing argon and serves as a binding site to anchor metal nanoparticles and colloids to the walls of the carbon nanofoam.

FIG. 7 shows (A) the sandwiched assembly of carbon fiber paper between glass microscope slides; (B) gradually sweeping the meniscus of RF (resorcinol-formaldehyde) solution across the fiber paper; (C) applying pressure to the glass slides with binder clips; (D) sealing the reaction assembly in duct tape; and (E) the aluminum pouch that contains the reaction assembly for processing within a pressure cooker.

The carbon nanofoam composites described herein offer a unique set of structural characteristics that sharply contrast with those of existing carbon materials. The nanofoam architecture comprises nanometric carbon walls and large surface areas that are bi-continuous with a network of ˜10-50 nm, ˜50-500 nm, or ˜500-1000 nm pores. Pore sizes in this regime are ideally proportioned for amplifying electrochemical interactions with various chemical environs. For example, the macropores in carbon nanofoams are perfectly sized and through-connected to accommodate the fluid transport and build-up of nanoparticles and molecular species, but are small enough that valuable device volume is not wasted on the cavernous voids found in most cellular carbon foams (10 s to 100 s of μm). See, J. W. Klett, U.S. Pat. No. 6,656,443, issued Dec. 2, 2003; Z. Fang, C. Li, J. Sun, H. Zhang, and J. Zhang, Carbon, 45, 2873 (2007); M. Kodama, J. Yamashita, Y. Soneda, H. Hatori, and K. Kamegawa, Carbon, 45, 1105 (2007); and M. Liu, L. Gan, F. Zhao, X. Fan, H. Xu, F. Wu, Z. Xu, Z. Hao, and L. Chen, Carbon, 45, 3042 (2007). In contrast, chemical fluxes are impeded by the diffusion limitations of the micropores (<2 nm), see L. Wang, J. Zhang, D. S. Su, Y. Ji, X. Cao, and F.-S. Xiao, Chem. Mater., 19, 2894 (2007) and mesopores (2-50 nm), see H. Tamon, H. Ishizaka, T. Yamamoto, and T. Suzuki, Carbon, 37, 2049 (1999); Y. Zhu, H. Hu, W.-C. Li, and X. Zhang, J. Power Sources, 162, 738 (2006); and J. GarcÍa-Martinez, T. M. Lancaster, and J. Y. Ying, Adv. Mater., 20, 288 (2008), that comprise most high-surface-area carbons.

The pearl-necklace macropore morphology and dimensions of the carbon nanofoam materials disclosed herein are unprecedented among other forms of carbon in the literature. The low-density nanofoam structure is believed to be related to hydrogen-bonding and dipole-dipole interactions between the carbon fiber paper after it has been mildly oxidized via plasma etching in moist air and the RF sol when it reaches optimal surface energy and viscosity upon oligomerizing for approximately four hours prior to infiltration. The plasma activation of carbon fibers is an established method that enhances the proton capacitance and uptake of metal ions at the increasingly polarized carbon interface. Plasmas ignited in the presence of water vapor enhance the flux of fluids through hydrophobic polymer and carbonaceous architectures, creating uniformly wetted composites with robust mechanical properties. Water plasmas generate a larger fraction of aliphatic carbon-oxygen bonding, albeit with a lower atomic percentage of oxygen than plasma etching in air or oxygen alone. The disclosed glow-discharge plasma technique rapidly oxidizes the carbon fibers in 3-D, avoiding unnecessarily wetting the papers by electrochemical oxidation and refluxing acid digestion. Plasma etching is a low-temperature process, unlike controlled combustions that can ash carbon surfaces. Ozonolysis may also successfully oxygenate the fiber papers at low temperature, but would alter the surface energy of the carbon fibers in ways that may prevent the pearl-necklace morphology as achieved with water/air plasmas.

In the absence of fabric supports, RF-carbon aerogel monoliths and films have been reported with micron-sized pores, but lack the electronic conductivity that is required for high-rate electrochemical devices and the degree of flexibility that the fabric provides. Carbon nanofoam composites exhibit four-point electronic conductivities of ˜200 S cm⁻¹, whereas unsupported RF carbon aerogels are at best only conductive to a few S cm⁻¹ because of their non-graphitized, low-density structures.

Likewise, fiber-supported RF-carbon aerogels have never achieved a similar macroporous morphology as the carbon nanofoam network, likely because none of the published reports pre-activate carbon fibers using plasma, thermal, or electrochemical etching. Under the best conditions, micron-scale RF-carbon granules are loosely assembled around fibers to create macropores on the order of a few microns. Most often, though, RF-carbon globules comprising small mesopores coat the individual fibers but do not occupy a large fraction of the void volume in the paper. Fiber composites with poor loading diminish the electrochemical activities of carbon electrodes per unit area and volume.

Pekala et al. infiltrated resorcinol-formaldehyde (RF) sols into Lydall carbon fiber papers, sandwiched composite sheets between glass sheets, cured RF resins in sealed containers to minimize the evaporation of water and formaldehyde, and pyrolyzed the cured papers under inert atmosphere. However, Pekala et al. used 70 w/v % RF(aq) precursor solutions to wet their fiber papers, and this concentration is essentially undiluted because neat RF(aq) solution contains 72 g of RF solid per 100 mL of solution. In contrast, we infiltrated RF precursor solutions with smaller solid fractions (32-44 w/v %) into our carbon fiber papers in order to target lower density aerogels with larger pore diameters. Pekala et al. did not directly characterize the pore size distribution of their materials, choosing instead to rely on the measure of electrochemical capacitance to assess the accessibility of their carbon aerogel papers. Our work emphasizes the importance of micrographic evidence and porosimetry to establish that the entire electrode is 3-D plumbed and has a high solid-volume filling fraction. None of the references teach or disclose using a pressure cooking scheme to synthesize RF polymers. The nanofoam preforms of the present invention are sealed within glass slides that are wrapped in duct tape and then pressure cooked, because moist heat is used to avoid the pore collapse that occurred in the earlier works.

Glora et al. advanced Pekala's initial research by considering the effects of other fiber compositions (PAN, novoloid, and carbon fiber fleeces) and also made the connection that a more dilute (30 wt. %) RF solution and a resorcinol-to-catalyst (R/C) ratio of 1500:1 resorcinol molecules per sodium carbonates promote larger pore sizes and finer pore morphologies in the resulting polycondensate product. Glora reported that the carbon aerogel materials formed around carbon fleece papers consisted of ˜100-nm colloids, but only documented their pore architecture with one electron micrograph at low magnification. While they reported an electronic conductivity of 28 S cm⁻¹, which is undoubtedly the result of synergistic conduits through both carbon phases, their publication left open many questions: (1) what is the surface chemistry of the carbon fleece that was used, (2) how was the carbon fleece treated prior to infiltration, (3) what was the filling fraction of the aerogel within the interfiber voids, (4) what was the pore morphology and size distribution of the aerogel, and (5) was the pore network uniformly plumbed throughout the aerogel paper. Our work is the first to truly answer these fundamental questions, which has been key to achieving the controllable pore/solid architectures comprising our nanofoam papers.

Petri\check{c}ević et al. and Wang et al. in essence reported similar work as their colleague above, themselves using dilute RF precursor solutions (25-30 wt %) with R/C ratios of 1500:1. Petri\check{c}ević surveyed oxide, cellulosic, polymer, and carbon fiber fleeces as frameworks from which to hang his polycondensate threads, but gave very limited micrographic evidence for 3-D plumbing throughout aerogel materials. Instead, Petri\check{c}ević relied heavily upon small-angle X-ray scattering (SAXS) measurements to determine the pore structure of the aerogel material. Scattering measurements of solid materials are limited in that they cannot determine the degree of interconnectedness between the pores—only that objects scatter within particular regimes of length. Furthermore, scattering models are unable to differentiate between pore morphologies that are clearly distinct when viewed via electron microscope. For example, Petri\check{c}ević used scanning electron microscopy to contrast the difference between micron-sized carbon colloids that cling to Saffil Al₂O₃ fibers and the delicate aerogel structure bound between SGL carbon fleece fibers, but the authors conclude from SAXS that both materials exhibit similar scattering behavior. Scattering measurements permeate the carbon aerogel literature, but should be taken as secondary evidence when electron microscopy is available, and the absence of direct micrographic evidence was a hindrance to advancing this innovative composite material a decade ago.

Petri\check{c}ević and Wang both observed dense surface skins on their carbon aerogel papers that would impede transport processes that are critical to electrochemical, catalytic, and separations applications. We initially observed similar surface layers, but realized that the repulsive interactions between the aqueous-based RF sol and the hydrophobic carbon fibers could be overcome by oxidizing the interface of individual fibers with a plasma discharge. Matching the surface energy of the fibers with that of the sol creates the perfect balance of forces such that nanofoam papers are hierarchically plumbed with a mixture of mesopores and macropores throughout. When surface forces are imbalanced, however, Wang's carbon fibers are draped in dense globules of carbon that are themselves non-starters for electrodes that are orders of magnitude larger than the molecular species they seek to interact with.

Carbon aerogel materials are modestly conductive (a few S cm⁻¹) on their own, and the chosen carbon fiber papers should imbue as much as electronic conductivity into the aerogel as possible. The carbon fiber fleeces employed by Petri\check{c}ević and Wang increase the conductivity of the aerogel paper by 2-4 times. Through our work with Toray and Lydall carbon fiber papers, it was immediately clear that papers with a greater number density of fibers increase the conductivity of the native aerogel architecture by as much as ten fold (as high as 220 S cm⁻¹), with potentially more increase possible if the fibers themselves are graphitized.

The carbon nanofoam pore architecture that we have developed has some morphological similarities to other two materials that were developed without fiber scaffolds. We wish to distinguish how our materials are unique and potentially more beneficial for electrochemical applications. Recent work by Hu et al. creates nanocast carbon monoliths upon silica foams with pore sizes ≧1 μm. In principle, their carbon replica is capable of fluxing matter through its pore network, but like many other templating approaches, the rapidity, cost, and safety issues that are inherent to nanocasting and chemically etching pre-fabricated silica structures prevents nanocasting from achieving the scale-up that is necessary for device manufacturing. Likewise, the resulting carbon foam is not flexible, offers a very modest electronic conductivity (0.1 S cm¹), and must be blended with binders to make electrodes—presenting further scaling challenges. Ultrasonic RF syntheses by Tonanon et al. have reportedly achieved similar random pore morphologies by cavitating RF precursor sols prior to gelation. While the tunable pore morphology that Tonanon achieves is desirable, the resulting product is also an inflexible monolith which we were repeatedly unable to replicate based on the experimental information given in their work. To their credit, their data relies heavily on SEM imaging and Hg porosimetry—two techniques that are critical to fully characterizing carbon architectures.

Our method of fabricating carbon nanofoam composites uses low-cost and readily available precursors, and is scalable to produce large planar sheets of high-surface-area carbons. Carbon nanofoam electrodes are applicable as porous electrodes and current collectors for energy storage devices with minimal geometric footprints. The porous carbon nanofoam architecture can serve as a stand-alone Li-ion-insertion anode or as a nanoscopic current collector for solid-state microbatteries in which all electrochemical components are fully interpenetrated in three dimensions. Likewise, the nanofoam architecture is well-suited as a 3D, nanoscopic support for MnO₂ hybrid electrochemical capacitors, or as a porous scaffold for semi-fuel cell electrocatalysts. The large interfacial areas of nanofoam materials also make them relevant for electrifiable membranes that can sense or remove even dilute chemical species from fluid streams.

The present method of fabricating carbon nanofoam composites uses low-cost and readily available precursors, and is scalable to produce large planar sheets of high-surface-area carbons. Carbon nanofoam electrodes are applicable as porous electrodes and current collectors for energy storage devices with minimal geometric footprints. The porous carbon nanofoam architecture can serve as a stand-alone Li-ion-insertion anode or as a nanoscopic current collector for solid-state microbatteries in which all electrochemical components are fully interpenetrated in three dimensions. Likewise, the nanofoam architecture is well-suited as a 3D, nanoscopic support for MnO₂ hybrid electrochemical capacitors, or as a porous scaffold for semi-fuel cell or fuel cell electrocatalysts. The large interfacial areas of nanofoam materials also make them relevant for electrifiable membranes that can sense or remove even dilute chemical species from fluid streams.

The foregoing examples have been presented for the purpose of illustration and description only and are not to be construed as limiting the scope of the invention in any way. The scope of the invention is to be determined from the claims appended hereto.

What is claimed as new and desired to be protected by Letters Patent of the United States is:

1. A method of fabricating a material comprising: plasma etching carbon paper in the presence of a gas containing O₂ and H₂O;
immersing said carbon paper in an oligomerized resorcinol-formaldehyde mixture until said carbon paper is impregnated with said mixture;
placing said impregnated carbon paper between two glass slides;
sealing said two slides such that the evaporation of said resorcinol-formaldehyde mixture from said carbon paper is slowed;
curing said carbon paper in a pressure cooker;
pyrolyzing said carbon paper to create a carbon nanofoam.

2. The method of claim 1 wherein said weight fraction of said resorcinol-formaldehyde (RF) mixture has a weight fraction that ranges from about 10% to about 50 wt %.

3. The method of claim 2 wherein said weight fraction of said resorcinol-formaldehyde (RF) mixture more preferably has a weight fraction that ranges from about 32% to about 44 wt %.

4. The method of claim 1 wherein said pressure cooker cures said carbon paper at a temperature ranging from about 85 to about 90° C.

5. The method of claim 1 wherein said gas containing O₂ and H₂O is provided by ice or water in the plasma chamber.

6. The product of the method of claim 1.

7. A method comprising:
exposing a porous structure comprising carbon fibers to resorcinol and formaldehyde or an oligomer thereof; and
polymerizing the resorcinol and formaldehyde or oligomer thereof to form a polymer network permeating at least a portion of the structure.

8. The method of claim 7, further comprising:
oxidizing at least a portion of the surface of the structure.

9. The method of claim 7, further comprising:
carbonizing the polymer.
